(19) United States
(12) Patent Application Publication
(10) Pub. No.: US 2013/0110606 A1
(43) Pub. Date: May 2, 2013

(54) REDUCTION OF POWER CONSUMPTION USING INCENTIVES

(71) Applicant: Siemens Aktiengesellschaft, Munich (DE)

(72) Inventors: Tolga Han Seyhan, Bethlehem, PA (US); Amit Chakraborty, East Windsor, NJ (US)

(73) Assignee: SIEMENS AKTIENGESELLSCHAFT, Munich (DE)

(21) Appl. No.: 13/651,515

(22) Filed: Oct. 15, 2012

Related U.S. Application Data
(60) Provisional application No. 61/553,361, filed on Oct. 31, 2011.

(51) Int. Cl. G06Q 30/00

(52) U.S. Cl. 705/14.25

(57) ABSTRACT

A method for reducing an amount of power consumed includes reading loads from meters of customers, predicting a future total load from the read loads, determining whether the future total load exceeds a threshold value, sending a request message including terms to at least one of the customers when the future total load exceeds the threshold value, and adjusting an electric bill of a corresponding one of the customers for a period of time based on whether the customer adhered to the terms.

### CROSS-REFERENCE TO RELATED APPLICATIONS

This application claims priority to U.S. Provisional Application No. 61/553,361 filed on Oct. 31, 2011, the disclosure of which is incorporated by reference herein.

### BACKGROUND OF THE INVENTION

1. Technical Field

The present disclosure relates generally to reduction of power consumption using incentives.

2. Discussion of Related Art

A power system may include one or more power stations that generate electric power for supply to one or more consumers. For example, a power station may include one or more generators, which are machines that convert mechanical power into electrical power by creating relative motion between a magnetic field and a conductor. The power system may include other mechanisms in addition to the generators to generate additional electric power. When demands on the power system exceed or come close to exceeding its limits, it can purchase additional supplies of electric power from one or more external power systems. However, the cost for this external supply of power typically exceeds the cost for power locally generated by the current power system. Accordingly, consumers may face increased costs.

Thus, there is a need for methods and systems that can better optimize the available power to reduce costs to consumers.

### SUMMARY OF THE INVENTION

According to an exemplary embodiment of the invention, a method for reducing an amount of power consumed includes reading loads from meters of customers, predicting a future total load from the read loads, determining whether the future total load exceeds a threshold value, sending a request message including terms to at least one of the customers when the future total load exceeds the threshold value, and adjusting an electric bill of a corresponding one of the customers for a period of time based on whether the customer adhered to the terms.

The loads may be read from the meters by a computer system sending a computer message across a computer network to each meter, and in response to the received computer messages, the meters may output computer reply messages to the computer system indicating the respective loads.

The request message may be a computer message that is transmitted across a computer network to each customer. The request message may be sent to each customer via one of an e-mail, a text message, a social network message, and an instant message. Each load may represent an amount of power required by the respective customer. The terms may indicate a rate to be charged during the time period if the customer agrees to reduce power consumption during the time period. The terms may indicate a limit on the amount of power allowed to be used by the customer during the time period.

The bill may be adjusted in response to receipt of a reply message from the corresponding customer indicating whether the terms were accepted and based on a current load of the corresponding customer during the period of time. The bill may be reduced if the customer accepted the terms and the current load is lower than a goal load. The predicting may be performed using a double exponential smoothing method.

According to an exemplary embodiment of the invention, a system for reducing an amount of power consumed includes a computer system comprising a memory for storing a computer program and a processor for executing the computer program. The computer program includes instructions for reading loads from meters of customers, predicting a future total load from the read loads, determining whether the future total load exceeds a threshold value, sending a request message including terms to at least one of the customers when the future total load exceeds the threshold value, and adjusting an electric bill of a corresponding one of the customers for a period of time based on whether the customer adhered to the terms.

According to an exemplary embodiment of the invention, a method for reducing an amount of power consumed includes reading loads from meters of customers, predicting a future total load from the read loads, determining whether the future total load exceeds a threshold value, sending a request message including terms to at least one of the customers when the future total load exceeds the threshold value, and reducing an amount of power provided to one of the customers for a period of time if the customer accepted the terms.

Each load may represent an amount of power required by the respective customer. The method may further include maintaining the amount of power at a higher level if the customer rejected the terms. The request message may be a computer message that is transmitted across a computer network to each customer. The terms may indicate a rate to be charged during the time period if the customer agrees to reduce power consumption during the time period. The terms may further indicate a limit on the amount of power allowed to be used by the customer during the time period. Each customer may accept the terms by sending a computer message indicating that the terms have been accepted. The predicting may be performed using a double exponential smoothing method.

According to an exemplary embodiment of the invention, a system for reducing an amount of power consumed includes a computer system comprising a memory for storing a computer program and a processor for executing the computer program. The computer program includes instructions for reading loads from meters of customers, predicting a future total load from the read loads, determining whether the future total load exceeds a threshold value, sending a request message including terms to at least one of the customers when the future total load exceeds the threshold value, and reducing an amount of power provided to one of the customers for a period of time if the customer accepted the terms.

According to an exemplary embodiment of the invention, a method for reducing an amount of power consumed includes predicting a first subsequent total load from current loads provided by meters of customers, determining whether the future total load exceeds a threshold value, sending a first request message to at least one of the customers when the first subsequent total load exceeds the threshold value, and sending a second request message to at least one of the customers only if the second subsequent total load exceeds the threshold value. The first request message indicates an incentive rate for reducing consumption during an event period. The second request message indicates the incentive rate reduced by a pre-determined factor.

### BRIEF DESCRIPTION OF THE DRAWINGS

Exemplary embodiments of the invention can be understood in more detail from the following descriptions taken in conjunction with the accompanying drawings in which:

FIG. 1 illustrates a method for reducing power consumption according to an exemplary embodiment of the invention.

FIG. 2 illustrates a system that can implement the method of FIG. 1, FIG. 3, or FIG. 4.

FIG. 3 illustrates a method for reducing power consumption according to an exemplary embodiment of the invention.

FIG. 4 illustrates a method for reducing power consumption according to an exemplary embodiment of the invention.

FIG. 5 illustrates an example of a computer system capable of implementing methods and systems according to embodiments of the present invention.

### DETAILED DESCRIPTION

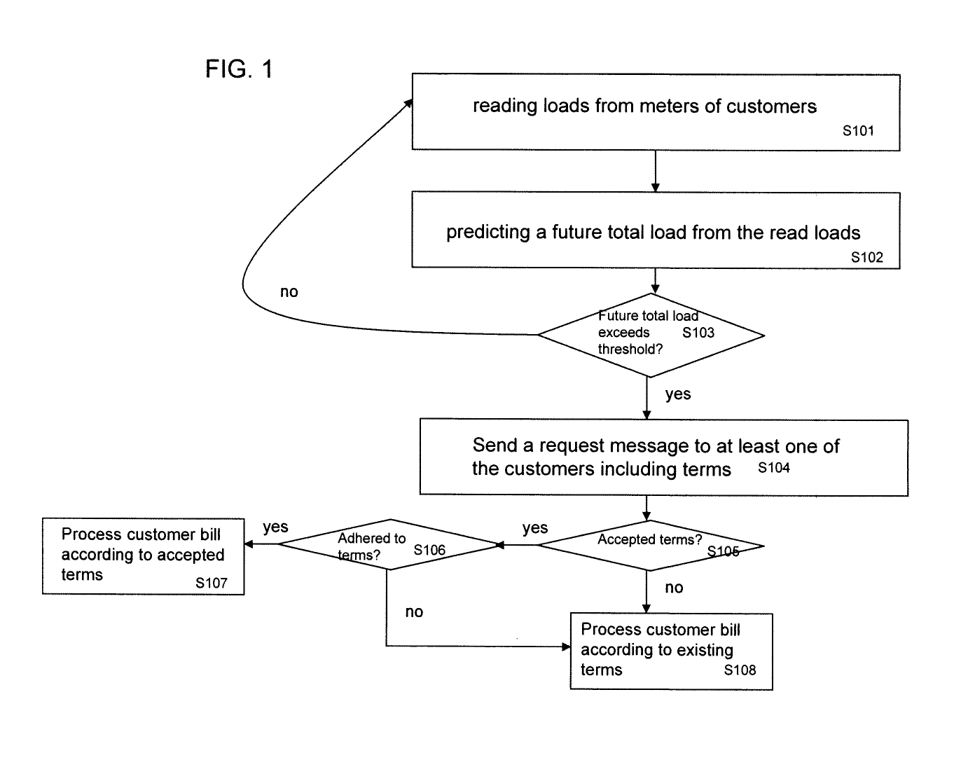

Exemplary embodiments of the invention are discussed in further detail with reference to FIGS. 1-5. This invention may, however, be embodied in different forms and should not be construed as limited to the embodiments set forth herein.

It is to be understood that the systems and methods described herein may be implemented in various forms of hardware, software, firmware, special purpose processors, or a combination thereof. In particular, at least a portion of the present invention may be implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures may be implemented in software, the connections between system modules (or the logic flow of method steps) may differ depending upon the manner in which the present invention is programmed. Given the teachings herein, one of ordinary skill in the related art will be able to contemplate these and similar implementations of the present invention.

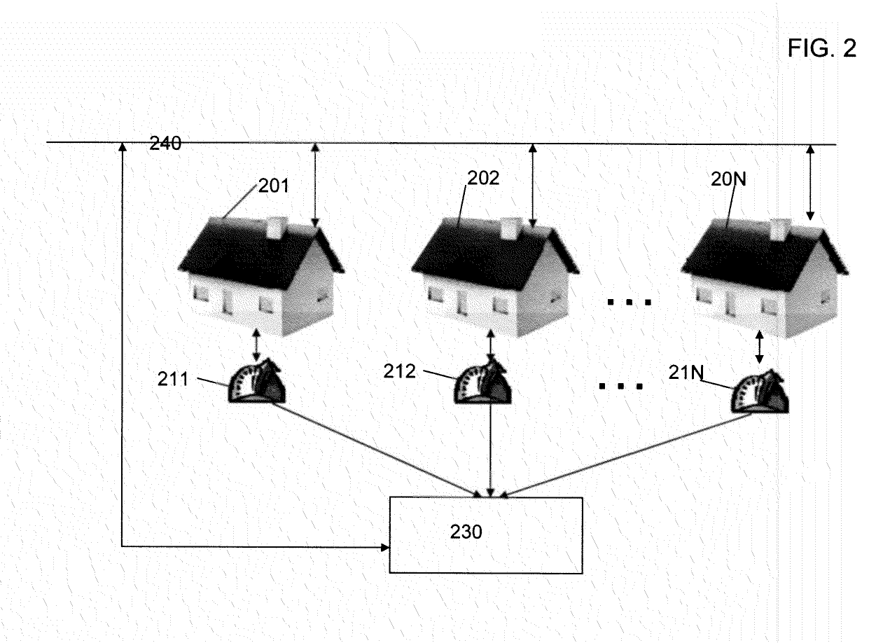

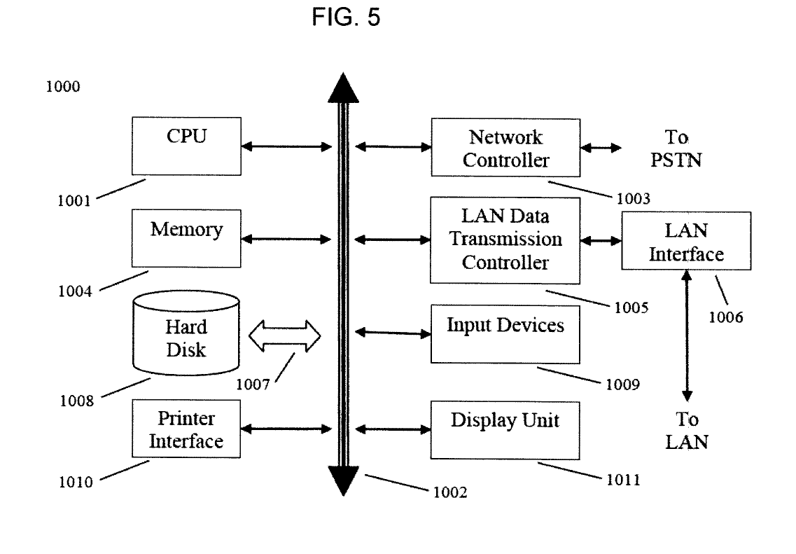

FIG. 1 illustrates a method for reducing power consumption according to an exemplary embodiment of the invention. FIG. 2 illustrates a system 230 that can be used to implement the method according to an exemplary embodiment of the invention. Referring to FIG. 1 and FIG. 2, the method includes system 230 reading loads from meters 211, 212, . . . , 21N (S101). The system 230 may be a computer such as the one illustrated in FIG. 5 as an example.

As shown in FIG. 1, each meter corresponds to one of the customers 201, 202, . . . , and 20N, where N an integer that is 1 or more. The meters 211-21 N can be smart meters. The smart meters are electrical meters that record consumption of electric energy in intervals (e.g., an hour or less). The system 230 can read this information by sending a request message to each meter, and then in response to each request message, the corresponding meter sends its respective information to the system 230. The meters can send their information to the system using a direct connection or via network 240. Alternately, the meters may periodically (e.g., hourly, daily, etc.) communicate this information through a direct connection to system 230 or via network 240. As an example, the network 240 is the internet, a wide area network, a local area network, or a wireless network, such as a cell phone network. The meters 211-21N may communicate using various protocols such as ANSI C12.18, IEC 61107, IEC 62056, Open smart grid protocol, etc.

The meters 211-21N can detect how much power a corresponding one of the customers 201-20N has used during a given period of time (e.g., over an hour, a day, a week, a month, etc.). The system 230 can send a computer message to each of meters 211-21N to request the current load on that meter. The meters 211-21N are configured to respond to these requests with a reply message (e.g., a computer message) indicating their corresponding electrical load requirements (e.g., some number of watts).

The loads of each of the customers 201-20N may differ based on what devices are being operated therein and the time of day. For example, if one customer is currently operating a clothes dryer, his load may be higher than another who is only operating a single lamp. Further, the loads of customers may vary based on the time of day. For example, typically the loads of customers are lower at night.

The system 230 predicts a future total load from the read loads (S102). For example, the system 230 combines the read loads from each of the meters 211-21N to generate a total load for a current time and then forecasts or predicts what the total load will be like at a future time. The system 230 may perform an ‘n’-hour-ahead forecast using the current total load, where n can be a positive fraction greater than 0 or a positive integer greater than 1. In at least one embodiment of the invention, the system 230 makes the forecast using a double exponential smoothing method. In this forecast method, a base and a trend value are recursively updated using exponentially decaying weights for older observations.

After the predicted total load has been calculated, the system 230 determines whether the predicted total load exceeds a threshold value (S103). The parameter Pₘₐₓ will be used to refer to the threshold value. For example, the threshold value Pₘₐₓ can be some number of watts, kilowatts, etc. If the predicted total load is below the threshold value Pₘₐₓ, the method returns to block S101 to again read the current loads from the meters 211-21N. The re-reading of the current loads may be delayed by a pre-defined sampling period. For example, if the sampling period is one day, the method would re-read the current loads the next day.

If the predicted total future load is greater than the threshold value Pₘₐₓ, the system 230 can initiate an event to send a message to one or more of the customers to request their participation in reducing the amount of power (S104). The event may be referred to as a demand response event, which is a “take-it or “leave-it” contract consisting of a desired power level P′, an incentive rate r′, and an event duration Δt.

For example, if there are 4 customers with identical load levels, and the threshold value Pₘₐₓ is 450 watts, the desired power level P′ for each customer could be 100 watts. The desired power level P′ for each customer could be calculated by dividing a goal power level P_{g} (e.g., 400 watts) by the number of customers (e.g., 400/4=100 watts). The goal power level P_{g} is typically less than or equal to the threshold value Pₘₐₓ. The incentive rate r′ is a discounted rate for power for the event period Δt that is lower than the current rate r_{c} for power. For example, when the current rate r_{c} is $0.107 per kWh, the incentive rate r′ could be $0.1 per KWh. The event duration Δt indicates a period of time during which the consumer has to reduce the amount of power they use to the desired power level P′ or lower in order to qualify for the incentive rate r′. For example, the event duration Δt could be between 4pm-6pm on Tuesday, the entire month of October, etc.

The message sent by the system 230 to request participation in the demand response event can be sent to each customer 201-20N across the network 240. The message can be sent as an email, a text message, etc. In at least one embodiment, the message merely requests that the user participate in reducing their use of electricity during the event duration Δt. For example, the message can display the event duration Δt and include text that asks the customer to indicate whether or not they want to participate. As an example, if the message is an email, the text could include instructions such as reply ‘y’ or ‘yes’ to participate or reply ‘n’ or ‘no’ to not participate and the event duration Δt.

The lack of an affirmative response within some time period of the event can be treated as the customer indicating their desire not to participate. For example, after the system 230 sends out the messages to the customers 201-20N to request participation, the system 230 can start a timer that ends on a time on or before the start of the event duration Δt. For example, if the system 230 sent out 10 messages to 10 customers, 3 of the 10 customers have not responded when the timer reaches its end time, the system 230 assumes that the remaining customers had indicated that they do not want to participate in the event.

In another example, if the message had been sent by the system 230 to a customer as a text message to a cellular phone number associated with the customer, the customer can respond to the text message with another text message using a similar response to indicate whether they want to participate.

In another example, the system 230 is configured to send a voice message to the telephone or cellular/smartphone associated with the customer with information about the event, that enables the customer indicate participation by pressing a key of the phone (e.g., ‘1’ to participate or ‘0’ to not participate).

The message requesting participation of the customer may include additional information such as the desired power level P′ for the event duration Δt, the incentive rate r′, the current rate r_{c} they will be charged if they do not participate, an estimated savings or profit if they participate, etc. The estimated savings may be generated using the current rate r_{c} and a predicted amount of power the customer is expected to use during the event duration Δt.

The message may also be sent to the customer using an instant message or a social network such as Facebook, Twitter, Linkedin, etc.

The system 230 may include a database or other storage mechanism to store contact information for each customer, their desired communication platform (e.g., text, email, social network), and any other required data needed to interface with the communication platform. In the case of a social network, if a utility runs the system 230, the utility can create a social network user account or use an existing one, which can be “friended” by each customer to allow the messages requesting participation to be sent.

In another example, a client application is downloaded to the customer's smart phone or tablet computer that interfaces with the system 230. The request for participation message would then be sent to the client application, which can display a notification window on the device to the consumer requesting their participation.

The details of the message requesting participation (e.g., the incentive rate r′, event duration Δt, desired power level P′) can be referred to as the terms (e.g., the terms of the agreement for the contracted incentive rate′). For example, if the customer responded to the message affirmatively, they have agreed to the terms.

The system 230 can determine whether each customer has accepted the terms in the request message based on their corresponding response or lack of response (S105). The system 230 may perform this determination prior to the event duration Δt.

If the customer has accepted the terms, then the system 230 determines whether the customer has adhered to the terms (S106). For example, the system 230 can query the meters of each customer to determine how much power the customer actually used during the event duration Δt. If the customer is determined to have adhered to the terms of the agreement, then the system 230 processes the bill of the customer according to the accepted terms (S107). For example, if the desired power level P′ is 100 watts and the customer only used 80 watts during the event duration Δt, the system 230 can log that the customer is to be charged the incentive rate r′ instead of the current rate r_{c}. If a customer had not accepted the terms, the system 230 can process their bill for the event duration Δt according to existing terms (e.g., the current rate r_{c}) (S108). For example, if the desired power level P′ is 100 watts and the customer used 110 watts during the event duration Δt, the system 230 can log that the customer is to be charged the current rate r_{c}.

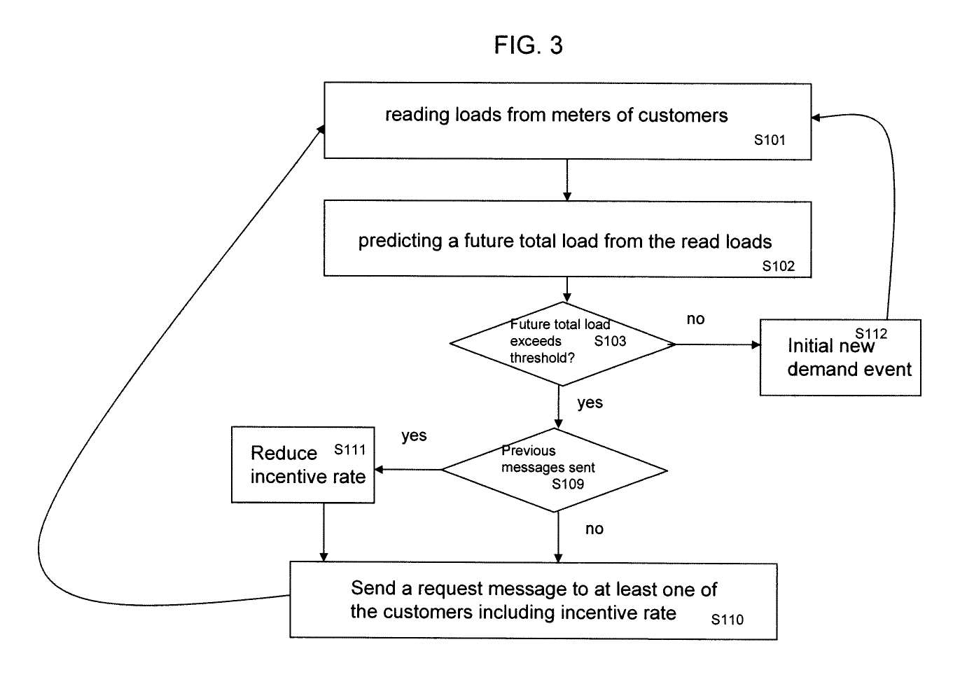

FIG. 3 illustrates a method for reducing power consumption according to an exemplary embodiment of the invention. Similar to FIG. 1, the method includes steps of reading the loads, predicting a future load from the read loads, and determining whether the future load exceeds the threshold (S101-S103). The method next determines whether previous messages have been sent for this same demand event (S109). Assuming this is the first time the method has been run for the current demand event, the answer will be ‘no’ and the method will proceed to send a request message to the customers including the current incentive rate (S110). The system 230 may set a message sent flag at this time indicating that it has sent out messages for the current demand event. The system 230 may also set a response flag for each customer that has responded to the demand event (e.g., Customer 1 response flag=1 if agreed or =0 if denied). In the next iteration, the method again checks whether the future total load exceeds the threshold by re-executing steps S101-S103. A delay may be present between each iteration to ensure that customers have enough time to alter their usage behavior. If the newly calculated future total load still exceeds the threshold, the method will again check whether previous messages for this demand event have been sent. In this case, the answer will be ‘yes’, and then the method proceeds to reduce the incentive rate r′ by some pre-determined factor (S111). Then the request messages are sent again using the updated incentive rate (S110). In an alternate embodiment, the request messages with the updated incentive rate are only sent those customers who did not abide by or did not agree to the terms of the previous request message. For example, the system 230 can refer to the response flags to determine whether a customer agreed to the event. The system 230 can then re-execute steps S101-S103. If the future total load does not exceed the threshold, the system 230 can perform an initialization for a subsequent demand event (S112). For example, in the initialization, the system 230 could clear the message sent flag and the response flags.

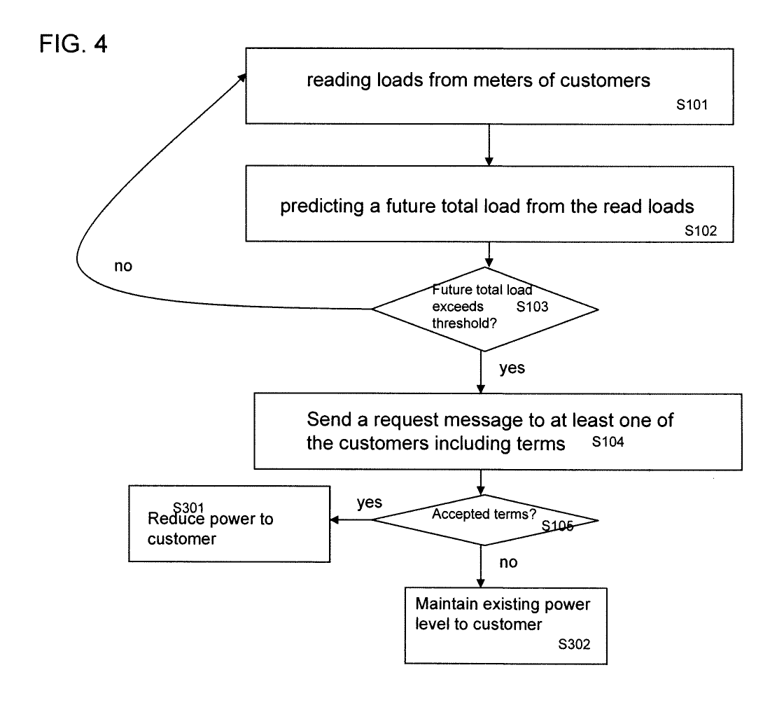

In the above examples, the system 230 does not modify the amount of power provided to each customer based on their respective participation. Thus, customers are free to use more power even though they agreed to participate. In a variation of the above described embodiment, the system 230 provides a reduced amount of power to a customer or to a power node that provides power to that customer that agreed to participate in the demand event during the event duration Δt and maintains the existing power level otherwise. FIG. 4 illustrates a modified version of the method of FIG. 1, but with additional steps S311 and S312. For example, if a customer agreed to the terms (i.e., agreed to participate in the demand response event), the amount of power supplied to the customer is reduced (S311). For example, if the desired power level P′ is 100 watts, the system 230 would only provide 100 watts of power to the customer during the event duration Δt. As discussed above, the system 230 may also reduce the amount of power provided to a power node that supplies power to the customer. Further, this power node may provide power to multiple customers, including those that did not agree to participate in the event. For example, if the power node generally receives 600 watts of power for delivering power to 4 customers (e.g., an average of 150 watts a customer), and only one is participating, the total amount of power to the node can be reduced to 550 watts during the event duration Δt since one of the customers has essentially agreed to accept 100 watts instead of his typical 150 watts.

If the customer had not agreed to the terms (e.g., vowed not to participate in the demand response event), the amount of power supplied to the customer is maintained at its existing level (S312). For example, the power node receiving 600 watts would continue to receive the same amount of power during the event duration Δt.

The customer is assumed to use the electricity as a means of production and hence earns a customer specific margin m over the current electricity expense r_{c}. The customer's current profit Cp can be determined by using the below equation 1 as follows:

Cp=m*P_{c}*Δt [Equation 1]

where P_{c} is the amount of power actually used by the customer during the event duration Δt. The customer's profit Cₚₐ if they accept the offer can be determined by using the below equation 2 as follows:

Cₚₐ=(r_{c}+m−r)*P′*Δt [Equation 2].

For example, if m=$0.002, the current rate r_{c} is $0.107/kWh, the incentive rate r′ is $0.1/kWh, and the desired power level P′ used by the customer during an event duration of 10 hours is 100 kW, then the customer's profit Cₚₐ would be ($0.107+$0.002−$0.100)*10*100 or about 90 cents. If the customer does not accept the terms of the agreement, and they instead use 150 kW during the same period of time, their profit would be 150*($0.107+0.02−0.107)=$0.30. A customer may accept the terms if P′*(r_{—}0+m−r′)>P_{—}0*m, which is simply P′ (r_{—}0−r′)−m*(P_{—}0−P′)>0, i.e., the benefit from reduced rate less the lost profit due to load reduction. The margin m is the minimum reduction in rate that would generate a “Yes” from the customer (e.g., agreed to terms). The margin m may be estimated using historical responses of the customer.

Each of the profits Cₚ and Cₚₐ can be provided to the customer in the message that requests participation of the customer in the demand request to assist them in determining whether they should agree to participate. As a result, the customers can reduce their loads to the requested level if it is more profitable for them to stay at that level until the demand response event is over, and return to their original levels afterwards.

In an exemplary embodiment of the invention, the demand response offers are externally set as in dead-ahead demand response events. Further, there may be multiple different types of offers made to a customer during a demand response event (e.g., different contract types). For example, these contract types could include a rebate for reductions where reductions from an upper bound are awarded and price-only contracts where a price increase is declared to reduce power demand. The upper bound could be determined using the recorded history of each customer. For example, the system 230 can record history data for each customer indicating their average load or average peak load for a period (e.g., a week, a month, a year). Thus, if their average load is X Kilowatts for last November, the upper bound could be some amount Y lower than X. Thus, when a demand event is initiated, the system 230 can request that the consumer lower their average usage by X-Y for the next month in order to qualify for the incentive rate or to receive a corresponding rebate. Further, the system 230 may store a different customer class for each customer, where each customer class is associated with a different seasonality factor. The average customer load for the prior period could then be multiplied by the seasonality factor to arrive at the upper bound. Examples of customer classes could include “private business”, “government entity”, “private residence”, etc. Examples of seasonality factors could include “winter private residence”, “winter private business”, etc., where each includes a multiplier. For example, if the average load last September for a consumer classified as a private residence was J Kilowatts, and the winter seasonality factor for private residence is 0.8, the upper bound for receiving a rebate could be J*0.8. The different customer classes and seasonality factors allow the system 230 to create a multitude of different rebate options that are suitable for many different types of customers.

Further, customer decision making mechanisms can be altered to include own and cross price elasticities of demand and inherent randomness related to the responding customer. For example, the system 230 can estimate a response curve for the customer (e.g., using price elasticity). Then the system 230 can optimize the load reduction that it will request from the customers through nonlinear programming.

FIG. 5 shows an example of a computer system, which may implement the methods and systems of the present disclosure. The system and methods of the present disclosure, or part of the system and methods, may be implemented in the form of a software application running on a computer system, for example, a mainframe, personal computer (PC), handheld computer, server, etc. For example, the methods of FIGS. 1, 3, and 4 may be implemented as software application(s). These software applications may be stored on a computer readable media (such as hard disk drive memory 1008) locally accessible by the computer system and accessible via a hard wired or wireless connection to a network, for example, a local area network, or the Internet. For example, the system 230 shown in FIG. 2 may correspond to the computer system shown in FIG. 5.

The computer system referred to generally as system 1000 may include, for example, a central processing unit (CPU) 1001, a GPU (not shown), a random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007. CPU 1001 may be the computer processor that performs some or all of the steps of the methods described above with reference to FIGS. 1-4.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention.

What is claimed is:

1. A method for reducing an amount of power consumed comprises:
reading loads from meters of customers;
predicting a future total load from the read loads;
determining whether the future total load exceeds a threshold value;
sending a request message including terms to at least one of the customers when the future total load exceeds the threshold value; and
adjusting an electric bill of a corresponding one of the customers for a period of time based on whether the customer adhered to the terms.

2. The method of claim 1, wherein the loads are read from the meters by a computer system sending a computer message across a computer network to each meter, and in response to the received computer messages, the meters output computer reply messages to the computer system indicating the respective loads.

3. The method of claim 1, wherein the request message is a computer message that is transmitted across a computer network to each customer.

4. The method of claim 1, wherein the request message is sent to each customer via one of an e-mail, a text message, a social network message, and an instant message.

5. The method of claim 1, wherein each load represents an amount of electrical power required by the respective customer.

6. The method of claim 1, wherein the terms indicate a rate to be charged during the time period if the customer agrees to reduce power consumption during the time period.

7. The method of claim 6, wherein the terms indicate a limit on the amount of power allowed to be used by the customer during the time period.

8. The method of claim 7, wherein the bill is adjusted in response to receipt of a reply message from the corresponding customer indicating whether the terms were accepted and based on a current load of the corresponding customer during the period of time.

9. The method of claim 8, wherein the bill is reduced if the customer accepted the terms and the current load does not exceed the limit.

10. The method of claim 1, wherein the predicting is performed using a double exponential smoothing method.

11. A system for reducing an amount of power consumed comprises:
a computer system comprising a memory for storing a computer program and a processor for executing the computer program,
wherein the computer program includes instructions for reading loads from meters of customers, predicting a future total load from the read loads, determining whether the future total load exceeds a threshold value, sending a request message including terms to at least one of the customers when the future total load exceeds the threshold value, and adjusting an electric bill of a corresponding one of the customers for a period of time based on whether the customer adhered to the terms.

12. The system of claim 11, wherein the terms indicate a rate to be charged during the time period if the customer agrees to reduce power consumption during the time period, and a limit on the amount of power allowed to be used by the customer during the time period.

13. The system of claim 12, wherein the computer program is configured to adjust the bill in response to receipt of a reply message from one of the customers indicating whether the terms are accepted and based on a current load of the corresponding customer during the period of time.

14. The system of claim 13, wherein the computer program reduces the bill if the customer accepted the terms and the current load is lower than the limit.

15. A method for reducing an amount of power consumed comprises:
reading loads from meters of customers;
predicting a future total load from the read loads;
determining whether the future total load exceeds a threshold value;
sending a request message including terms to at least one of the customers when the future total load exceeds the threshold value; and
reducing an amount of power provided to one of the customers for a period of time if the customer accepted the terms.

16. The method of claim 15, wherein each load represents an amount of electrical power required by the respective customer.

17. The method of claim 15, further comprises maintaining the amount of power at a higher level if the customer rejected the terms.

18. The method of claim 15, wherein the request message is a computer message that is transmitted across a computer network to each customer.

19. The method of claim 15, wherein the terms indicate a rate to be charged during the time period if the customer agrees to reduce power consumption during the time period.

20. The method of claim 19, wherein the terms further indicate a limit on the amount of power allowed to be used by the customer during the time period.

21. The method of claim 15, wherein the customer accepts the terms by sending a computer message indicating that the terms have been accepted.

22. The method of claim 19, wherein the predicting is performed using a double exponential smoothing method.

23. A method for reducing an amount of power consumed comprises:
predicting a first subsequent total load from current loads provided by meters of customers;
determining whether the future total load exceeds a threshold value;
sending a first request message to at least one of the customers when the first subsequent total load exceeds the threshold value, the first request message indicating an incentive rate for reducing consumption during an event period;
predicting a second subsequent total load from current loads provided by meters of the customers; and
sending a second request message to at least one of the customers only if the second subsequent total load exceeds the threshold value, the second request message indicating the incentive rate reduced by a pre-determined factor.

24. The method of claim 23, wherein the threshold value is based on a previous average load for one of the customers.

25. The method of claim 24, wherein the request messages are sent by a computer system as computer messages to computers of the at least one customers.
